(19) United States
(12) Patent Application Publication
(10) Pub. No.: US 2025/0369606 A1
(43) Pub. Date: Dec. 4, 2025

(54) Color Changing Cabinets Device

(71) Applicant: Anthony Klingshirn, Hoover, AL (US)

(72) Inventor: Anthony Klingshirn, Hoover, AL (US)

(21) Appl. No.: 19/074,567

(22) Filed: Mar. 10, 2025

Related U.S. Application Data
(60) Provisional application No. 63/652,730, filed on May 29, 2024.

(51) Int. Cl. F21V 33/00; F21S 10/02; F21V 23/02; F21V 23/04

(52) U.S. Cl. CPC F21V 33/0016; F21S 10/02; F21V 23/045; A47B 97/00; A47B 2220/0077

(57) ABSTRACT

A color changing device is disclosed, which allows homeowners, designers, and builders to change the look and color of interior and exterior home décor in a low cost and effective manner. The color changing device comprises a frame component that can be positioned around cabinets, siding, shutters, etc., and secured with clips or other securing means. The frame component comprises a white PVC material with a clear or transparent face. Between the face and the PVC material is a set of built-in variable LED lighting that can be changed via a remote control and powered via electricity or solar panels. Thus, users can activate the LEDs at any time with the remote control and alter their look and color.

### CROSS-REFERENCE TO RELATED APPLICATION

The present application claims priority to, and the benefit of, U.S. Provisional Application No. 63/652,730, which was filed on May 29, 2024, and is incorporated herein by reference in its entirety.

### FIELD OF THE INVENTION

The present invention relates generally to the field of color changing devices. More specifically, the present invention relates to color changing frames capable of being installed within cabinets, siding, shutters, and other home interior and exterior areas. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in color changing devices. Generally, people may enjoy altering the look of different areas of their home to match a specific aesthetic. Further, replacing cabinets, drawers, siding, and shutters can be difficult. These fixtures are often made to be permanent and the only way to alter their look is through expensive maintenance and/or replacement. Additionally, painting over these items to change their color or look may not be effective.

Furthermore, some users utilize energy-efficient light-emitting diodes (LEDs) to change the colors of various objects. LEDs are extremely efficient, as LEDs have a high lumen output and a distinctly low power consumption. Some users have even begun to utilize colored LEDs, such as red-green-blue LEDs (RGB-LEDs), to incorporate various colors into an object. Further, LEDs can be used to project light onto an image and create a brighter and more interactive image in a display or object.

Accordingly, there is a demand for an improved color changing device that provides users with color changing frames capable of being installed within cabinets, siding, shutters, and other home interior and exterior areas. More particularly, there is a demand for a color changing device that reduces maintenance and renovation costs associated with changing color schemes in a home.

Therefore, there exists a long-felt need in the art for a color changing device that allows homeowners, designers, and builders to change the look and color of interior and exterior home décor in a low cost and effective manner. There is also a long-felt need in the art for a color changing device that provides users with color changing frames capable of being installed within cabinets, siding, shutters, and other home interior and exterior areas. Further, there is a long-felt need in the art for a color changing device that enables users to change the color of their cabinets, sidings, and shutters via the plastic frame, LEDs, and a remote control. Moreover, there is a long-felt need in the art for a device that utilizes electricity or solar energy to power the lights and ensure they can be altered at any time. Further, there is a long-felt need in the art for a color changing device that reduces maintenance and revocation costs associated with changing color schemes in a home. Finally, there is a long-felt need in the art for a color changing device that functions as an environmentally safe method of renovating homes compared to full replacements, painting, etc.

The subject matter disclosed and claimed herein, in one embodiment thereof, comprises a color changing device. The device allows homeowners, designers, and builders to change the look and color of interior and exterior home décor in a low cost and effective manner. The color changing device comprises a frame component that can be positioned around cabinets, siding, shutters, etc., and secured with clips or other securing means. The frame component comprises a white PVC material with a clear or transparent face. Between the face and the PVC material is a set of built-in variable LED lighting that can be changed via a remote control and powered via electricity or solar panels. Thus, users can activate the LEDs at any time with the remote control and alter their look and color. The device is intended to reduce renovation and maintenance costs associated with changing the look and aesthetics of cabinets, siding, and shutters.

In this manner, the color changing device of the present invention accomplishes all of the foregoing objectives and provides users with a device that changes the color of cabinets, sidings, and shutters via a plastic frame with LEDs and a remote control. The device can be powered via electricity or solar panels. The device can be applied to a variety of objects, as desired.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a color changing device. The device allows homeowners, designers, and builders to change the look and color of interior and exterior home décor in a low cost and effective manner. The color changing device comprises a frame component that can be positioned around cabinets, siding, shutters, etc., and secured. The frame component comprises variable LED lighting that can be changed via a remote control. Thus, users can activate the LEDs at any time with the remote control and alter their look and color. The device is intended to reduce renovation and maintenance costs associated with changing the look and aesthetics of cabinets, siding, and shutters.

The presently-disclosed subject matter relates to color changing objects. In particular, the presently-disclosed subject matter relates to color changing objects that incorporate one or more lights to produce a color changing illumination and change the appearance of an object, such as kitchen cabinets, bedroom furniture, siding, shutters, and other suitable home interior and exterior areas.

In one embodiment, the color changing device includes a frame component that is applied to the outer perimeter of the kitchen cabinets, bedroom furniture, siding, shutters, etc. The frame component would encompass the entire outer perimeter of the object to be illuminated. Typically, the frame component would be secured to the object perimeter via clips, staples, etc., or any other suitable securing means as is known in the art.

In one embodiment, the frame component can be fabricated from a variety of materials including wood, plastic, and/or metal, or any other suitable material as is known in the art. Typically, the frame component is manufactured of a white PVC material. Specifically, the frame component includes a back surface and a front surface, with the back surface comprised of a white PVC material and the front surface is a clear or transparent face. The clear or transparent face allows light being emitted to shine through and reflect on the object that the frame component frames.

In one embodiment, between the transparent face and the white PVC material is a set of built-in variable LED lighting. The LED lighting is secured to the inner back surface via any suitable securing means as is known in the art. The lights are used to produce a color changing illumination that can be directed toward the interior of the object that is framed by the frame component. It is contemplated that the lights could be in any of a number of positions, but specifically, it is contemplated that the LEDs would be in such a position that light transmitted from the LEDs would be diffused inward toward the interior of the object, to illuminate the entire object a specific color. Further, each light can produce either a single color light or a plurality of color lights, such that the light source (i.e., all of the lights taken collectively) produce the different light colors.

In one embodiment, the LED lighting further includes a controller and a power supply, both of which are secured to the frame component. In this regard, the controller can be operably connected to the lights and used to control the amount and the color of the light that is being emitted from the lights. Of course, the power supply is connected to the controller and is used to provide power to the lights and the controller. As would be recognized by those of ordinary skill in the art, any suitable power supply can be used in accordance with the presently-disclosed subject matter including, but not limited to, battery packs, AC/DC adapters, and the like. In some embodiments, the controller and power supply are housed in a compartment (not shown) of the frame component such that the compartment can slide outward to allow a user to view, access, and manipulate the controller, the power supply, and any other component of the color changing device.

In one embodiment, the LED lighting utilizes a plurality of solar panels as a power supply. In this embodiment, the plurality of solar panels are connected to the LED lighting and the controller and include a converter for converting the solar energy into power for the LED lighting.

In one embodiment, the LEDs are one or more lights that are comprised of a red-green-blue light-emitting diode (RGB-LED), which is comprised of one red, one blue, and one green diode. By using the RGB-LEDs in the color changing device, it has been found that the light being emitted from the RGB-LEDs can effectively be used to smoothly transition the light emitted from the lights between the pure colors of the full-spectrum of light, and thus create an appearance that the combined image is fading from one image to the next. Specifically, it has been found that by varying the voltage to each colored diode of the RGB-LED, the voltage to one colored diode can be decreased, while the voltage of the next diode is increased proportionally to thereby provide a smooth transition between colors.

In some embodiments, the RGB-LEDs are arranged in strips of RGB-LEDs. Furthermore, in some embodiments, one or more lights, such as the RGB-LEDs, can be addressable such that certain of the lights emit one desired color while one or more other lights are emitting different colors.

In some embodiments of the presently-disclosed color changing device, the lights comprise an addressable matrix of RGB-LEDs, where the color of each RGB-LED can be controlled independently. In constructing an addressable matrix of RGB-LEDs, a circuit is typically created, where each diode is placed in series with a source resistor (Rₛ) and is also connected to a voltage source (Vₛ). The voltage source provides a means of independently controlling the behavior of the individual LEDs, whereas the source resistors are used to limit the current that passes through the diodes, as LEDs are current-dependent devices.

In one embodiment, although the lights have been described herein with reference to RGB-LEDs, it is contemplated that the lights can be comprised of numerous other types of lights that are capable of transmitting different colors of light and transitioning between those different colors. Exemplary types of additional lights that may be used in accordance with the presently-disclosed subject matter include, but are not limited to, incandescent lights, CFLs, fixed-lights with color changing bulbs, etc.

In one embodiment, the LEDs of the color changing device are controlled by a remote controller. The remote controller would have a plurality of buttons representing the variety of colors that the LEDs can be programmed to.

In one embodiment, the device further includes a wireless communication module and additional sensors which would allow the device to pair with a mobile application on a mobile or smart device. Once paired, a user could control the colors of the LEDs via the mobile application.

In yet another embodiment, the color changing device comprises a plurality of indicia.

In yet another embodiment, a method of changing the color of cabinets, siding, or shutters is disclosed. The method includes the steps of providing a color changing device comprising a frame component with built-in LED lighting. The method also comprises securing the frame component around cabinets, shutters, or siding, as desired. Further, the method comprises powering the built-in LED lighting via electricity or solar panels. The method also comprises activating the built-in LED lighting with a remote control. Finally, the method comprises changing the colors of the LED lighting via the remote control, as desired.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the color changing device of the present invention showing the device implemented on kitchen cabinets in accordance with the disclosed architecture;

FIG. 2 illustrates a perspective view of one embodiment of the color changing device of the present invention showing the remote control in accordance with the disclosed architecture;

FIG. 3 illustrates a perspective view of one embodiment of the color changing device of the present invention showing a piece of furniture illuminated with the device in accordance with the disclosed architecture;

FIG. 4 illustrates a perspective view of one embodiment of the color changing device of the present invention showing how the light color can be adjusted with the remote in accordance with the disclosed architecture;

FIG. 5 illustrates a perspective view of one embodiment of the color changing device of the present invention showing the device implemented into exterior home shutters in accordance with the disclosed architecture; and

FIG. 6 illustrates a flowchart showing the method of changing the color of cabinets, siding, or shutters in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a color changing device that allows homeowners, designers, and builders to change the look and color of interior and exterior home décor in a low cost and effective manner. There is also a long-felt need in the art for a color changing device that provides users with color changing frames capable of being installed within cabinets, siding, shutters, and other home interior and exterior areas. Further, there is a long-felt need in the art for a color changing device that enables users to change the color of their cabinets, sidings, and shutters via the plastic frame, LEDs, and a remote control. Moreover, there is a long-felt need in the art for a device that utilizes electricity or solar energy to power the lights and ensure they can be altered at any time. Further, there is a long-felt need in the art for a color changing device that reduces maintenance and revocation costs associated with changing color schemes in a home. Finally, there is a long-felt need in the art for a color changing device that functions as an environmentally safe method of renovating homes compared to full replacements, painting, etc.

The present invention, in one exemplary embodiment, is a novel color changing device. The device allows homeowners, designers, and builders to change the look and color of interior and exterior home décor in a low cost and effective manner. The color changing device comprises a frame component that can be positioned around cabinets, siding, shutters, etc., and secured with clips or other securing means. The frame component comprises a white PVC material with a clear or transparent face. Between the face and the PVC material is a set of built-in variable LED lighting that can be changed via a remote control and powered via electricity or solar panels. Thus, users can activate the LEDs at any time with the remote control and alter their look and color. The present invention also includes a novel method of changing the color of cabinets, siding, or shutters. The method includes the steps of providing a color changing device comprising a frame component with built-in LED lighting. The method also comprises securing the frame component around cabinets, shutters, or siding, as desired. Further, the method comprises powering the built-in LED lighting via electricity or solar panels. The method also comprises activating the built-in LED lighting with a remote control. Finally, the method comprises changing the colors of the LED lighting via the remote control, as desired.

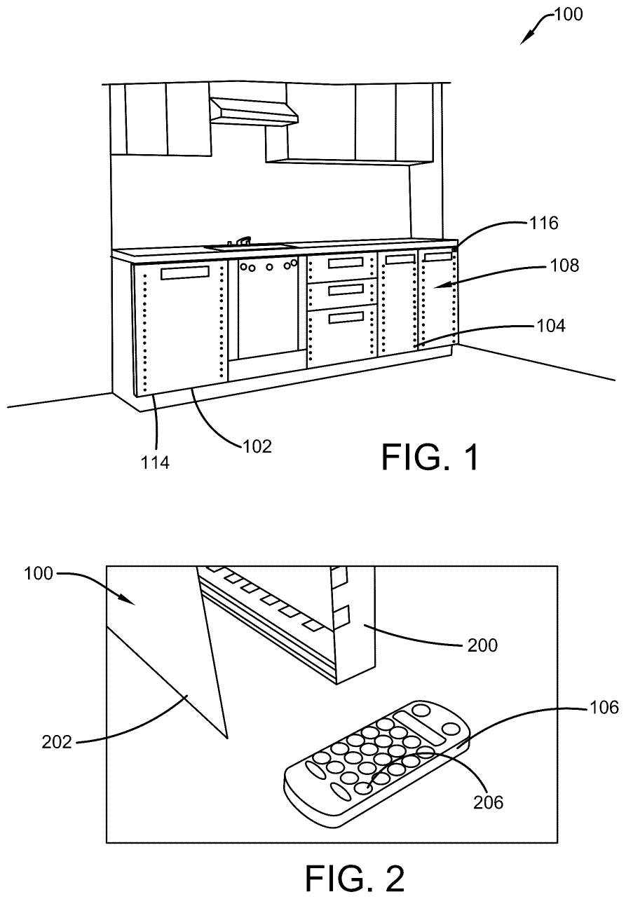

Referring initially to the drawings, FIG. 1 illustrates a perspective view of one embodiment of the color changing device 100 of the present invention. In the present embodiment, the color changing device 100 is an improved color changing device 100 that provides a user with color changing frames capable of being installed within cabinets, siding, shutters, and other home interior and exterior areas. Specifically, the color changing device 100 comprises a frame component 102 that can be positioned around cabinets 108, siding, shutters 110, furniture 112, etc., and secured. The frame component 102 comprises variable LED lighting 104 that can be changed via a remote control 106. Thus, users can activate the LEDs 104 at any time with the remote control 106 and alter their look and color. The device 100 is intended to reduce renovation and maintenance costs associated with changing the look and aesthetics of cabinets 108, siding, furniture 112, and shutters 110.

Generally, the presently-disclosed subject matter relates to color changing objects (i.e., cabinets 108, shutters 110, furniture 112, etc.). In particular, the presently-disclosed subject matter relates to color changing objects that incorporate one or more lights 104 to produce a color changing illumination and change the appearance of an object, such as kitchen cabinets 108, bedroom furniture 112, siding, shutters 110, etc., and other suitable home interior and exterior areas.

Further, the color changing device 100 includes a frame component 102 that is applied to the outer perimeter 114 of the kitchen cabinets 108, bedroom furniture 112, siding, shutters 110, etc. The frame component 102 would encompass the entire outer perimeter 114 of the object (i.e., cabinets 108, shutters 110, furniture 112, etc.) to be illuminated. Typically, the frame component 102 would be secured to the object perimeter 114 via clips 116, staples, etc., or any other suitable securing means as is known in the art.

As shown in FIG. 2, the frame component 102 can be fabricated from a variety of materials including wood, plastic, and/or metal, or any other suitable material as is known in the art. Typically, the frame component 102 is manufactured of a white PVC material. Specifically, the frame component 102 includes a back surface 200 and a front surface 202, with the back surface 200 comprised of a white PVC material and the front surface 202 is a clear or transparent face. The clear or transparent face (i.e., front surface 202) allows light being emitted to shine through and reflect on the object (i.e., cabinets 108, shutters 110, furniture 112, etc.) that the frame component 102 frames.

Further, between the transparent face (i.e., front surface 202) and the white PVC material (i.e., back surface 200) is a set of built-in variable LED lighting 104. The LED lighting 104 is secured to the inner back surface 200 via any suitable securing means as is known in the art. The lights 104 are used to produce a color changing illumination that can be directed toward the interior 204 of the object (i.e., cabinets 108, shutters 110, furniture 112, etc.) that is framed by the frame component 102. It is contemplated that the lights 104 could be in any of a number of positions, but specifically, it is contemplated that the LEDs 104 would be in such a position that light transmitted from the LEDs 104 would be diffused inward toward the interior 204 of the object (i.e., cabinets 108, shutters 110, furniture 112, etc.), to illuminate the entire object a specific color. Further, each light 104 can produce either a single color light or a plurality of color lights, such that the light source 104 (i.e., all of the lights taken collectively) produce the different light colors.

Additionally, the LEDs 104 of the color changing device 100 are controlled by a remote controller 106. The remote controller 106 would have a plurality of buttons 206 representing the variety of colors that the LEDs 104 can be programmed to. The remote controller 106 is typically powered by at least one battery.

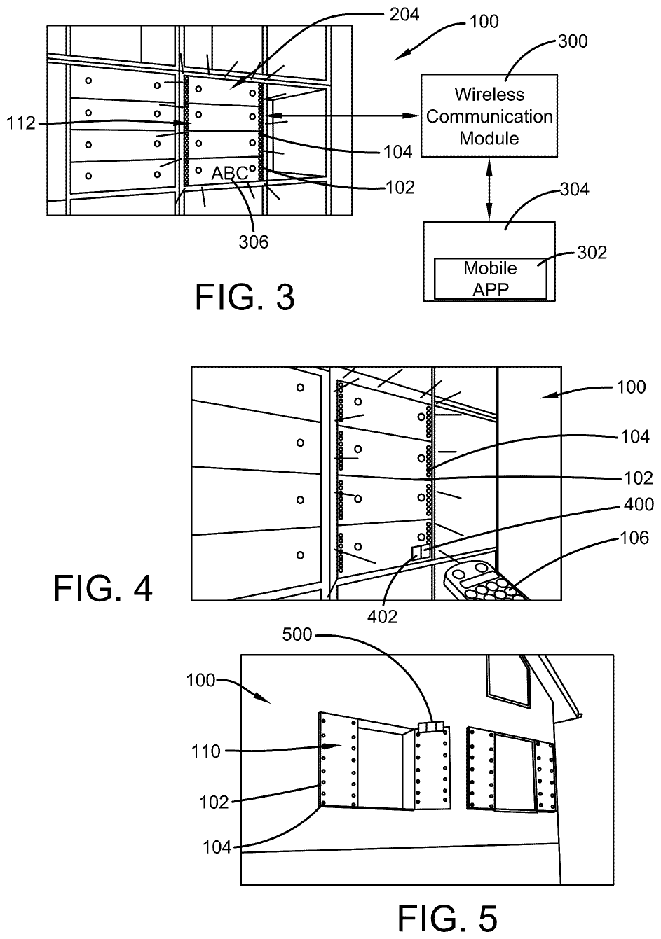

As shown in FIG. 3, the LEDs 104 are one or more lights that are comprised of a red-green-blue light-emitting diode (RGB-LED), which is comprised of one red, one blue, and one green diode. By using the RGB-LEDs in the color changing device 100, it has been found that the light being emitted from the RGB-LEDs can effectively be used to smoothly transition the light emitted from the lights 104 between the pure colors of the full-spectrum of light, and thus create an appearance that the combined image is fading from one image to the next. Specifically, it has been found that by varying the voltage to each colored diode of the RGB-LED, the voltage to one colored diode can be decreased, while the voltage of the next diode is increased proportionally to thereby provide a smooth transition between colors.

In some embodiments, the RGB-LEDs are arranged in strips of RGB-LEDs. Furthermore, in some embodiments, the one or more lights 104, such as the RGB-LEDs, can be addressable such that certain of the lights 104 emit one desired color while one or more other lights are emitting different colors.

In some embodiments of the presently-disclosed color changing device 100, the lights 104 comprise an addressable matrix of RGB-LEDs, where the color of each RGB-LED can be controlled independently. In constructing an addressable matrix of RGB-LEDs, a circuit is typically created (not shown), where each diode is placed in series with a source resistor (Rₛ) and is also connected to a voltage source (Vₛ). The voltage source provides a means of independently controlling the behavior of the individual LEDs, whereas the source resistors are used to limit the current that passes through the diodes, as LEDs are current-dependent devices.

In another embodiment, the device 100 further includes a wireless communication module 300 and additional sensors which would allow the device 100 to pair with a mobile application 302 on a mobile or smart device 304. Once paired, a user could control the colors of the LEDs 104 via the mobile application 302 instead of the remote controller 106.

In yet another embodiment, the color changing device 100 comprises a plurality of indicia 306. The frame component 102 of the device 100 may include advertising, a trademark, or other letters, designs, or characters, printed, painted, stamped, or integrated into the frame component 102, or any other indicia 306 as is known in the art. Specifically, any suitable indicia 306 as is known in the art can be included, such as, but not limited to, patterns, logos, emblems, images, symbols, designs, letters, words, characters, animals, advertisements, brands, etc., that may or may not be LED, cabinet, shutters, or brand related.

As shown in FIG. 4, although the lights 104 have been described herein with reference to RGB-LEDs, it is contemplated that the lights 104 can be comprised of numerous other types of lights that are capable of transmitting different colors of light and transitioning between those different colors. Exemplary types of additional lights that may be used in accordance with the presently-disclosed subject matter include, but are not limited to, incandescent lights, CFLs, fixed-lights with color changing bulbs, etc.

Furthermore, the LED lighting 104 further includes a controller 400 and a power supply 402, both of which are secured to the frame component 102. In this regard, the controller 400 can be operably connected to the lights 104 and used to control the amount and the color of the light that is being emitted from the lights 104. Of course, the power supply 402 is connected to the controller 400 and is used to provide power to the lights 104 and the controller 400. As would be recognized by those of ordinary skill in the art, any suitable power supply 402 can be used in accordance with the presently-disclosed subject matter including, but not limited to, battery packs, AC/DC adapters, and the like. In some embodiments, the controller 400 and power supply 402 are housed in a compartment (not shown) of the frame component 102 such that the compartment can slide outward to allow a user to view, access, and manipulate the controller 400, the power supply 402, and any other component of the color changing device 100.

As shown in FIG. 5, the LED lighting 104 utilizes a plurality of solar panels 500 as a power supply. In this embodiment, the plurality of solar panels 500 are connected to the LED lighting 104 and the controller 400 and include a converter for converting the solar energy into power for the LED lighting 104. In use, users secure the frame component 102 around a perimeter of a cabinet 108, shutters 110, or furniture 112 via a plurality of clips 116. The device 100 can then be plugged in, utilize a battery pack, or utilize solar panels 500 for power. A user can then utilize a remote controller 106 to turn off/on the device 100 and change the colors of the lights 104, as desired.

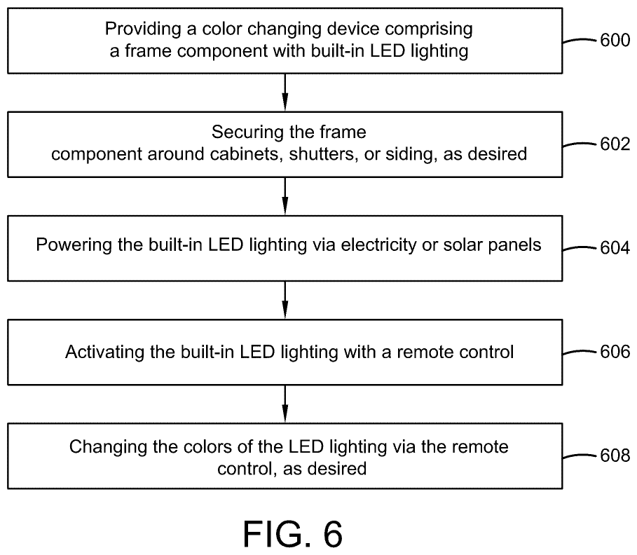

FIG. 6 illustrates a flowchart of the method of changing the color of cabinets, siding, or shutters. The method includes the steps of at 600, providing a color changing device comprising a frame component with built-in LED lighting. The method also comprises at 602, securing the frame component around cabinets, shutters, or siding, as desired. Further, the method comprises at 604, powering the built-in LED lighting via electricity or solar panels. The method also comprises at 606, activating the built-in LED lighting with a remote control. Finally, the method comprises at 608, changing the colors of the LED lighting via the remote control, as desired.

Notwithstanding the forgoing, it is also contemplated that the panels can also be frosted or tinted and attached by magnets. It is further contemplated that the lights can also be built into the cabinets, shutters, siding, etc. at the manufacturer's discretion.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “color changing device”, “changing device”, and “device” are interchangeable and refer to the color changing device 100 of the present invention.

Notwithstanding the foregoing, the color changing device 100 of the present invention can be of any suitable size and configuration as is known in the art without affecting the overall concept of the invention, provided that it accomplishes the above-stated objectives. One of ordinary skill in the art will appreciate that the color changing device 100 as shown in FIGS. 1-6 is for illustrative purposes only, and that many other sizes and shapes of the color changing device 100 are well within the scope of the present disclosure. Although the dimensions of the color changing device 100 are important design parameters for user convenience, the color changing device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A color changing device that provides a user with color changing frames installed on desired objects to change colors, the color changing device comprising:
a frame component;
wherein the frame component is positioned around cabinets, siding, shutters, or furniture and secured;
wherein the frame component comprises variable LED lighting; and
further wherein colors of the variable LED lighting can be changed, as desired by a user to illuminate the cabinets, siding, shutters, or furniture with a different color.

2. The color changing device of claim 1, wherein the frame component is applied to an outer perimeter of the cabinets, siding, shutters, or furniture.

3. The color changing device of claim 2, wherein the frame component is secured via clips.

4. The color changing device of claim 3, wherein the frame component is fabricated from a white PVC material.

5. The color changing device of claim 4, wherein the frame component includes a back surface and a front surface.

6. The color changing device of claim 5, wherein the back surface is comprised of the white PVC material and the front surface is a transparent face.

7. The color changing device of claim 6, wherein between the transparent face and the white PVC material is a set of built-in variable LED lighting.

8. The color changing device of claim 7, wherein the set of built-in variable LED lighting is used to produce a color changing illumination that can be directed toward an interior of an object framed by the frame component.

9. The color changing device of claim 8, wherein the set of built-in variable LED lighting is positioned such that light transmitted from the set of built-in variable LED lighting would be diffused inward toward the interior of the object to illuminate the object a specific color.

10. The color changing device of claim 9, wherein the set of built-in variable LED lighting is controlled by a remote controller.

11. The color changing device of claim 10, wherein the set of built-in variable LED lighting are comprised of a red-green-blue light-emitting diode (RGB-LED).

12. The color changing device of claim 11, wherein the set of built-in variable LED lighting is arranged in strips of RGB-LEDs.

13. A color changing device that provides a user with color changing frames installed on desired objects to change colors, the color changing device comprising:
a frame component applied to an outer perimeter of an object to be illuminated;
wherein the object to be illuminated includes cabinets, siding, shutters, or furniture;
wherein the frame component is secured via clips;
wherein the frame component includes a back surface and a front surface;
wherein the back surface is comprised of a white PVC material and the front surface is a transparent face;
wherein between the transparent face and the white PVC material is a set of built-in variable LED lighting;
wherein the set of built-in variable LED lighting is used to produce a color changing illumination that can be directed toward an interior of an object framed by the frame component; and
further wherein a controller and a power supply are secured to the frame component and operably connected to the built-in variable LED lights and used to control amount and color of light that is being emitted from the built-in variable LED lights.

14. The color changing device of claim 13 further comprising a wireless communication module and additional sensors which would allow the color changing device to pair with a mobile application on a smart device.

15. The color changing device of claim 14, wherein once paired, a user could control colors of the variable LED lighting via the mobile application.

16. The color changing device of claim 13 further comprising a plurality of indicia.

17. The color changing device of claim 13, wherein the set of built-in variable LED lighting are comprised of a red-green-blue light-emitting diode (RGB-LED).

18. The color changing device of claim 13, wherein the set of built-in variable LED lighting is controlled by a remote controller.

19. The color changing device of claim 13, wherein a plurality of solar panels is used to power the variable LED lighting.

20. A method of changing the color of cabinets, siding, or shutters, the method comprising the following steps:
providing a color changing device comprising a frame component with built-in LED lighting;
securing the frame component around cabinets, shutters, or siding, as desired;
powering the built-in LED lighting via electricity or solar panels;
activating the built-in LED lighting with a remote control; and
changing the colors of the LED lighting via the remote control, as desired.
